(19) United States
(12) Patent Application Publication
(10) Pub. No.: US 2025/0252552 A1
(43) Pub. Date: Aug. 7, 2025

(54) TWO-STEP METHOD FOR HIGH RESOLUTION SYNTHETIC DEFECT IMAGE GENERATION

(71) Applicant: Samsung Display Co., Ltd., Yongin-si (KR)

(72) Inventors: Kaushik Balakrishnan, San Jose, CA (US); Rahul Shenoy, San Jose, CA (US); Zhihong Pan, San Jose, CA (US); Qisen Cheng, San Jose, CA (US); Janghwan Lee, San Jose, CA (US)

(21) Appl. No.: 18/800,478

(22) Filed: Aug. 12, 2024

Related U.S. Application Data
(60) Provisional application No. 63/549,279, filed on Feb. 2, 2024.

(51) Int. Cl. G06T 7/00; G06T 5/50; G06T 7/50; G06T 11/00; G06V 10/25; G06V 10/764

(52) U.S. Cl. CPC G06T 7/0008; G06T 5/50; G06T 7/50; G06T 11/00; G06V 10/25; G06V 10/764; G06T 2207/20132; G06T 2207/20221; G06T 2207/30121

(57) ABSTRACT

A method of generating high-resolution synthetic images includes training a first diffusion model on a corpus of real images of a first class and real images of a second class; generating a synthetic image of the first class from a real image of the second class, and a synthetic image of the second class from a real image of the first class; determining at least one region of interest of the real images of the second class; cropping the real images of the first class and the real images of the second class based on the region of interest to generate a corpus of cropped images; training a second diffusion model on the cropped images; generating synthetic images of the first class from the corpus of cropped images;

and superimposing the images of the first class on the real images of the second class to generate the high-resolution synthetic images.

### CROSS-REFERENCE TO RELATED APPLICATION(S)

The present application claims priority to and the benefit of U.S. Provisional Application No. 63/549,279, filed Feb. 2, 2024, the entire content of which is incorporated herein by reference.

### BACKGROUND

### 1. Field

The present disclosure relates to methods for generating synthetic defect images.

### 2. Description of the Related Art

Defects generated during the manufacturing process of a display device (e.g., organic light-emitting diode (OLED) devices or quantum dot organic light-emitting diode (QD-OLED) devices) need to be detected with high accuracy for efficiency and robustness. A lot of the current defect identification, classification, and repair is undertaken by human personnel in the Remote Operator System (ROS), which is time-consuming, expensive, and prone to human error.

To make the manufacturing process more robust, an artificial intelligence defect classification and repair system may be utilized. However, balance between the number of defect-free images and the number of defect images is necessary to train a robust defect detection classifier, but this is not practical because the number of defective samples in manufacturing are typically a very small subset of the total production, such as only 1-2%.

The above information disclosed in this Background section is only for enhancement of understanding of the background of the invention and therefore it may contain information that does not constitute prior art.

### SUMMARY

The present disclosure relates to various embodiments of a method of generating high-resolution synthetic defect images. In one embodiment, the method includes training a first multi-class-conditioned diffusion model on a corpus of real defect images and real defect-free images of a display device at a stage during a manufacturing process. The method also includes generating, utilizing the first multi-class-conditioned diffusion model, a synthetic defect image from a real defect-free image, and a synthetic defect-free image from a real defect image; determining, utilizing the first multi-class-conditioned diffusion model, at least one region of interest of the real defect-free images; cropping the real defect images and the real defect-free images based on at least one region of interest to generate a corpus of cropped images; training a second multi-class-conditioned diffusion model on the corpus of cropped images; generating, with the second multi-class-conditioned diffusion model, synthetic defect images from the corpus of cropped images; and superimposing the plurality of synthetic defect images on the real defect-free images to generate the high-resolution synthetic defect images.

The real images of the first class may be real defect images of a display device at a stage during a manufacturing process, the real images of the second class may be real defect-free images of the display device at the stage during the manufacturing process, the synthetic images of the first class may be synthetic defect images, the synthetic image of the first class nay be a synthetic defect image, the real image of the second class may be a real defect-free image, the synthetic image of the second class may be a synthetic defect-free image, the real image of the first class may be a real defect image, and the high-resolution synthetic images may be high-resolution synthetic defect images.

Determining the region of interest may include determining at least one difference between the synthetic defect image and the real defect-free image or between the synthetic defect-free image and the real defect image; separating, utilizing a connected components algorithm, at least one difference into at least one distinct spot representing a defect; and determining a centroid of at least one distinct spot.

The region of interest may be centered about the centroid.

The region of interest may be offset with respect to the centroid.

The method may include determining regions of interest having different configurations.

The regions of interest may include a first region of interest having a first shape and a second region of interest having a second shape different than the first shape.

The regions of interest may include a first region of interest having a first orientation and a second region of interest having a second orientation different than the first orientation.

The regions of interest may include a first region of interest having a first aspect ratio and a second region of interest having a second aspect ratio different than the first aspect ratio.

The regions of interest may include a first region of interest having a first resolution and a second region of interest having a second shape resolution than the first resolution.

Generating the synthetic defect images may include utilizing at least one mask.

The at least one mask may include masks having different configurations.

The method may also include training an artificial intelligence classifier on the high-resolution synthetic defect images to detect defects in the display device.

The method may also include auto-repairing the defects in the display device.

The synthetic defect image may have a low-resolution and the real defect-free image may have a high-resolution, and the synthetic defect-free image may have the low-resolution and the real defect image may have the high-resolution.

The high-resolution may be 2048×2048, and the low-resolution may be 512×512.

Training the second multi-class-conditioned diffusion model may include training two or more second multi-class-conditioned diffusion models to generate synthetic defect images having two or more different configurations.

Training the second multi-class-conditioned diffusion models may include training one of the second multi-class-conditioned diffusion models to generate first synthetic defect images having a first size and training another one of the second multi-class-conditioned diffusion models to generate second synthetic defect images having a second size different than the first size.

Training the second multi-class-conditioned diffusion models may include training one of the second multi-class-conditioned diffusion models to generate first synthetic defect images having a first shape and training another one of the second multi-class-conditioned diffusion models to generate second synthetic defect images having a second shape different than the first shape.

Training the second multi-class-conditioned diffusion models may include training one of the second multi-class-conditioned diffusion models to generate first synthetic defect images having a first orientation and training another one of the second multi-class-conditioned conditioned diffusion models to generate second synthetic defect images having a second orientation different than the first orientation.

Training the second multi-class-conditioned diffusion models may include training one of the second multi-class-conditioned diffusion models to generate first synthetic defect images having a first resolution and training another one of the second multi-class-conditioned diffusion models to generate second synthetic defect images having a second resolution different than the first resolution.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable system or method.

### BRIEF DESCRIPTION OF THE DRAWINGS

The features and advantages of embodiments of the present disclosure will be better understood by reference to the following detailed description when considered in conjunction with the drawings. The drawings are not necessarily drawn to scale.

FIG. 1 is a flowchart illustrating tasks of a method of generating synthetic defect images according to one embodiment of the present disclosure;

FIG. 2 depicts the generation of synthetic defect images and synthetic defect-free images by a first diffusion model according to one task of the method;

FIG. 3 depicts a real defect-free image supplied to the first diffusion model and a synthetic defect image generated by the first diffusion model according to one task of the method;

FIG. 4A depicts a comparison of a real defect-free image to a synthetic defect image according to one task of the method;

FIG. 4B depicts the identification of spots, and the centroids of those spots, which represent defects according to one task of the method;

FIG. 4C depicts the identification of regions of interest based on the spots according to one task of the method;

FIG. 5A depicts cropping a real high-resolution defect-free image according to one task of the method;

FIG. 5B depicts cropping a real high-resolution defect image according to one task of the method;

FIGS. 6A-6C depict cropped images having different configurations according to one task of the method;

FIG. 7 depicts training a second diffusion model with cropped images according to one task of the method;

FIG. 8 depicts sampling the second diffusion model to generate synthetic defect images according to one task of the method;

FIGS. 9A-9C depict masks having different configurations according to one task of the method;

FIG. 10 depicts superimposing a cropped synthetic defect image on a real image to generate a high-resolution synthetic defect image according to one task of the method;

FIG. 11 is a flowchart illustrating tasks of a method of repairing defects in a display device according to one embodiment of the present disclosure; and

FIG. 12 is a flowchart illustrating tasks of a method of generating synthetic images containing an object of interest according to one embodiment of the present disclosure.

### DETAILED DESCRIPTION

The present disclosure relates to various methods of generating high-resolution synthetic defect images. These defect images may be utilized to train an artificial intelligence-based classification model to identify defects in a manufacturing process for fabricating display devices, such as a backplane manufacturing process for organic light-emitting diode (OLED) devices or quantum dot organic light-emitting diode (QD-OLED) devices. Once the defects are detected by the Al-based classification model, an auto-repair process may be utilized to repair the identified defects. In one or more embodiments, the method utilizes a first diffusion model to generate synthetic defect images, the Connected Components algorithm to identify regions of interest in the synthetic defect images, and crops the synthetic defect images to the region of interest. In one or more embodiments, the method also utilizes a second diffusion model to generate a defect in the region of interest (the cropped image) and then superimposes the generated defect image into the original high-resolution image to generate a high-resolution synthetic defect image. The methods of the present disclosure are configured to reduce the computational power required to generate the synthetic defect images compared to related art methods of generating synthetic defect images. For instance, a conventional method utilizing a diffusion model to generate high-resolution synthetic defect images (e.g., images having a resolution of 2048×2048) may require 32-64 GPUs running for approximately one week, whereas the method according to the present disclosure may require only 4 GPUs with a one-week runtime to achieve the same high-resolution synthetic defect images.

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

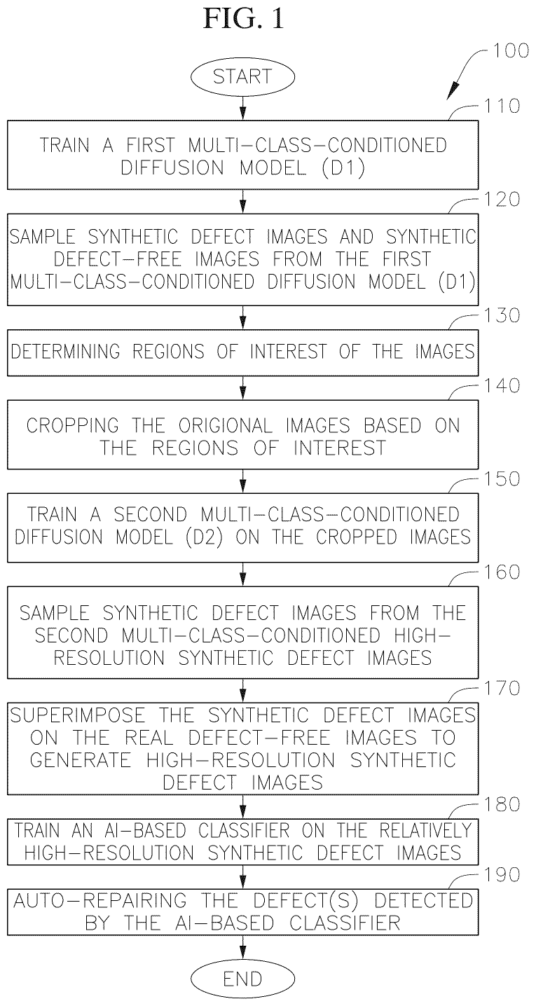

FIG. 1 is a flowchart illustrating tasks of a method 100 of generating high-resolution synthetic defect images according to one embodiment of the present disclosure. In the illustrated embodiment, the method 100 includes a task of obtaining or acquiring a data corpus including a plurality of relatively high-resolution real images of a portion of a display device (e.g., the circuitry of an OLED or a QD-OLED device) during one or more different manufacturing stages. The data corpus includes relatively high-resolution real defect images (i.e., actual images of the display device containing one or more defects) and relatively high-resolution real defect-free images (i.e., actual images of the display device not containing defects).

In the illustrated embodiment, the method 100 also includes a task 110 of training a first multi-class-conditioned diffusion model (D1) on the data corpus for each manufacturing stage (e.g., the stage(s) of manufacturing the gate and the source/drain regions) of the display device. In task 110, the first diffusion model is trained to generate images at a lower resolution than the images input into the first diffusion model (i.e., the first diffusion model is trained to resize images from a relatively high-resolution to a relatively lower resolution). For instance, in one or more embodiments, the task 110 may include training the first diffusion model to resize images having a resolution of 2048×2048 to images having a resolution of 512×512, although in one or more embodiments the higher resolution images and the lower resolution images may have any other suitable resolutions and the images may not be square.

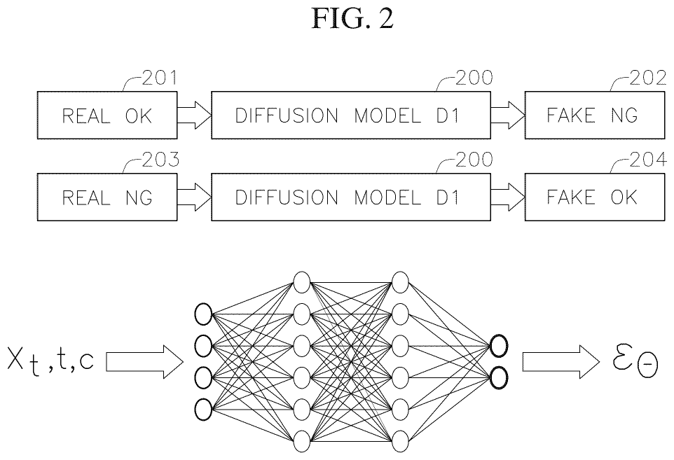

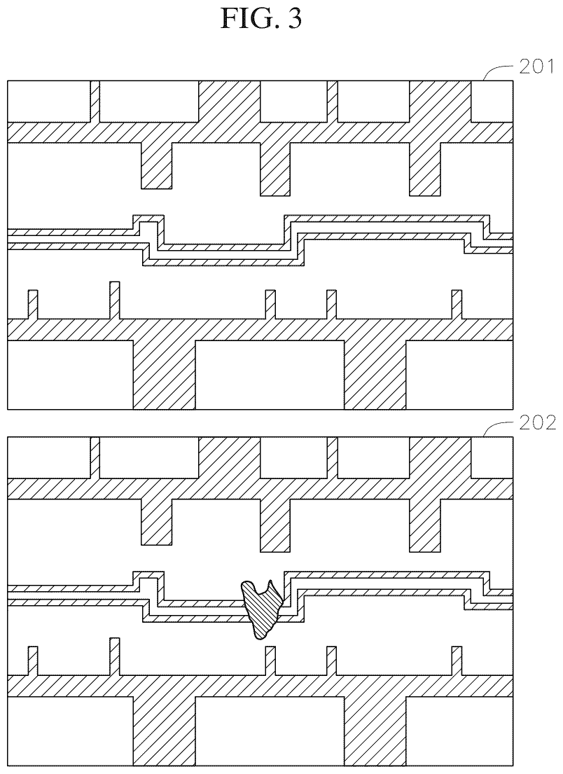

In the illustrated embodiment, the method 100 also includes a task 120 of sampling from the trained first diffusion model to obtain both synthetic defect images and synthetic defect-free images. In one or more embodiments, the task 120 includes supplying (e.g., randomly selecting) a real defect-free image to the first diffusion model. In the forward diffusion process, the first diffusion model is configured to iteratively add noise to the real defect-free image. In the reverse diffusion process, the first diffusion model is configured to denoise the image with class label c (desired synthetic defect image) to generate the synthetic defect image. In one or more embodiments, the class label c may refer to a defect-free image class or a defect type class, and the number of different types of defects for a given product could be, for example, in a range from 1 to 20. In one or more embodiments, the task 120 also includes supplying (e.g., randomly selecting) a real defect image to the first diffusion model. In the forward diffusion process, the first diffusion model is configured to iteratively add noise to the real defect image. In the reverse diffusion process, the first diffusion model is configured to denoise the image with class label c (desired synthetic defect-free image) to generate the synthetic defect-free image. FIG. 2 is a block diagram depicting the first diffusion model 200 receiving a real defect-free image 201 and generating (outputting) a synthetic defect image 202 according to task 110. FIG. 2 also depicts the first diffusion model 200 receiving a real defect image 203 and generating (outputting) a synthetic defect-free image 204 according to task 120. FIG. 3 depicts the real defect-free image 201 supplied to the first diffusion model and the synthetic defect image 202 generated by the first diffusion model according to task 120. Throughout the figures, defect images are labeled “NG” and defect-free images are labeled “OK.”

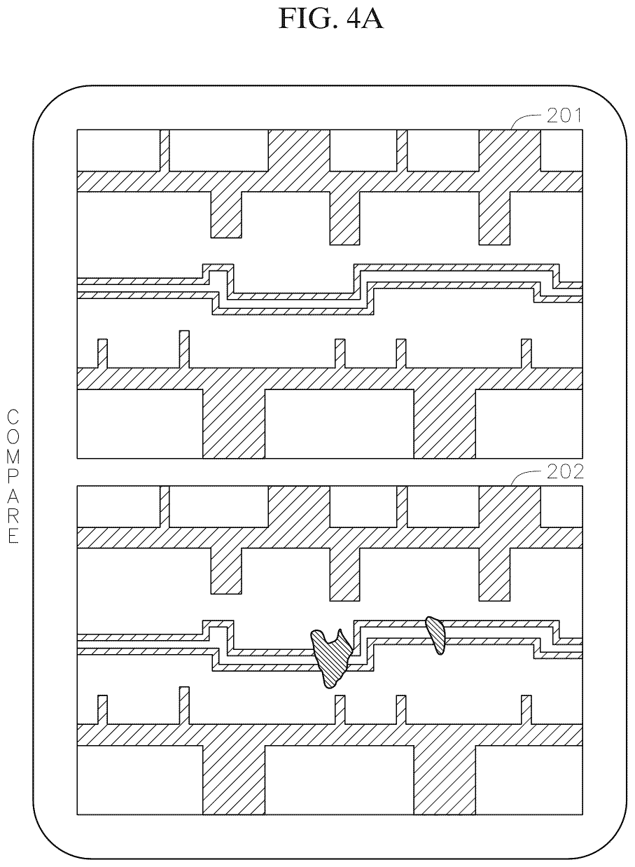

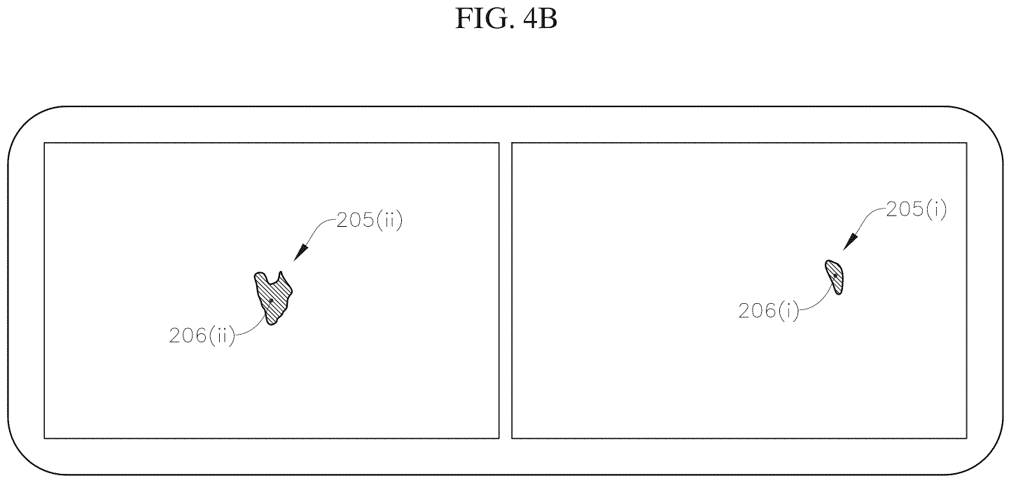

In the illustrated embodiment, the method 100 also includes a task 130 of determining a region(s) of interest of the images. In one or more embodiments, the task 130 of determining the region(s) of interest includes determining (e.g., calculating or computing) a difference between the real defect-free image 201 supplied to the first diffusion model 200 and the corresponding synthetic defect image 202 generated by the first diffusion model 200 and/or the difference between the real defect image 203 supplied to the first diffusion model 200 and the corresponding synthetic defect-free image 204 generated by the first diffusion model 200 (i.e., determining the difference between each pair of a real defect-free image and a corresponding synthetic defect image and/or between each pair of a real defect image and a corresponding synthetic defect-free image). FIG. 4A depicts the task 130 of comparing real defect-free image 201 to the synthetic defect image 202 generated by the first diffusion model 200.

Additionally, in one or more embodiments, the task 130 of determining the region(s) of interest also includes utilizing the connected components algorithm to separate the differences between the image pairs into distinct blobs or spots, each of which corresponds to one defect. In one or more embodiments, the task 130 also includes determining (e.g., calculating) a centroid (in coordinates specifying the row and column of the centroid) of each of the spots determined by the connected components algorithm. FIG. 4B depicts the spots 205(i), 205(ii) and the centroids 206(i), 206(ii), respectively, of those spots 205(i), 205(ii) determined in task 130.

In one or more embodiments, the task 130 also includes defining the area(s) of interest based on the spots 205(i), 205(ii) and the centroids 206(i), 206(ii). Defining the area(s) of interest may include projecting the centroids 206(i), 206(ii) of the spots 205(i), 205(ii) (which were determined on the relatively low-resolution images) onto the corresponding location on the relatively high-resolution real images. For instance, in one or more embodiments, the task 120 includes projecting the coordinates of the centroids 206(i), 206(ii) of the spots 205(i), 205(ii), respectively, onto the relatively high-resolution real images. Additionally, in one or more embodiments, the task 130 of defining the area(s) of interest includes generating at least one shape (e.g., a square or a rectangle) including (or surrounding) each centroid. For instance, in one or more embodiments, for each centroid 206(i), 206(ii), the task 130 may include defining a square or a rectangle having a fixed or constant height (in rows) above and below the centroid 206(i) or 206(ii) and a fixed or constant width (in columns) to the left and the right of the centroid 206(i) or 206(ii). FIG. 4C depicts the regions of interest 207(i), 207(ii) identified in task 130 projected on the relatively high-resolution real images.

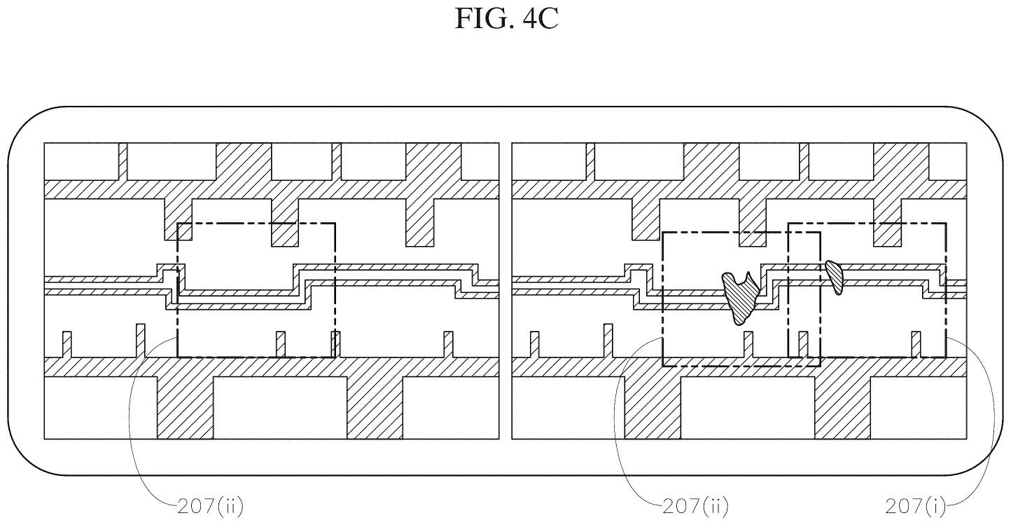

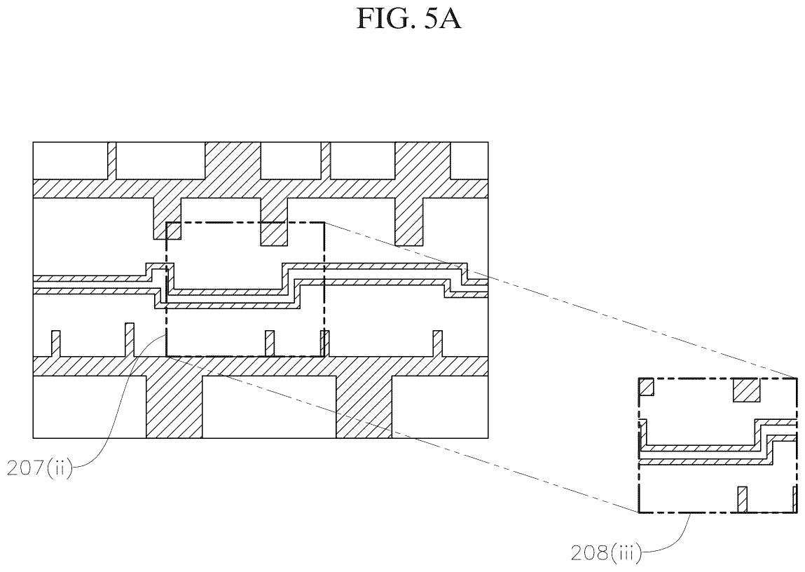

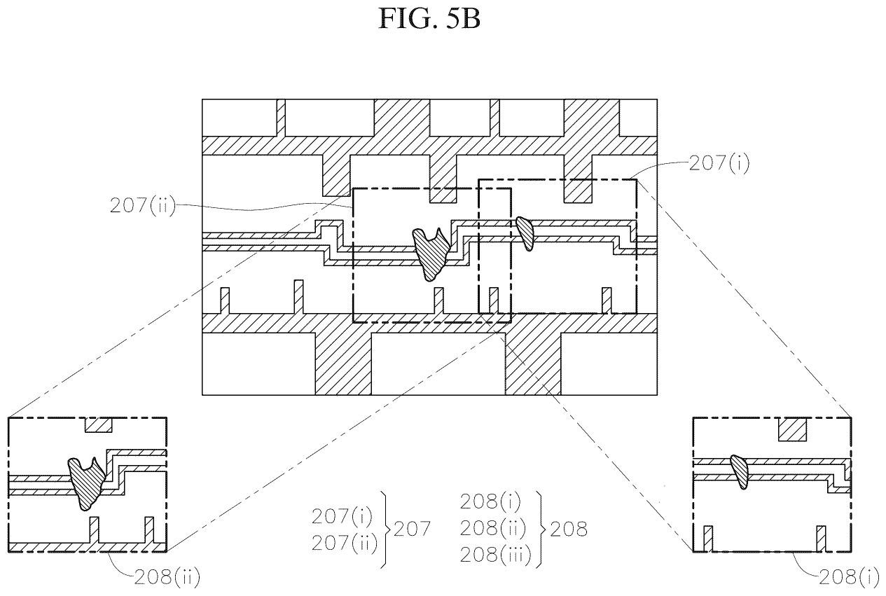

In the illustrated embodiment, the method 100 also includes a task 140 of cropping the original high-resolution real images based on the area(s) of interest 207 determined in task 130 (i.e., cropping the original high-resolution real images based on the location of the spots and the centroids thereof). In this manner, the task 130 generates a corpus of cropped real defect images and cropped real defect-free images. In one or more embodiments, the task may include defining two or more areas of interest in an image and thus the number of cropped images in the corpus of cropped images may be larger than the number of original real images in the corpus of real images. FIG. 5A depicts cropping a real high-resolution defect-free image based on one region of interest 207(ii) to produce a cropped defect-free image 208(iii), and FIG. 5B depicts cropping a real high-resolution defect image based on two regions of interest 207(i) and 207(ii) to produce two cropped defect images 208(i) and 208(ii), according to task 140.

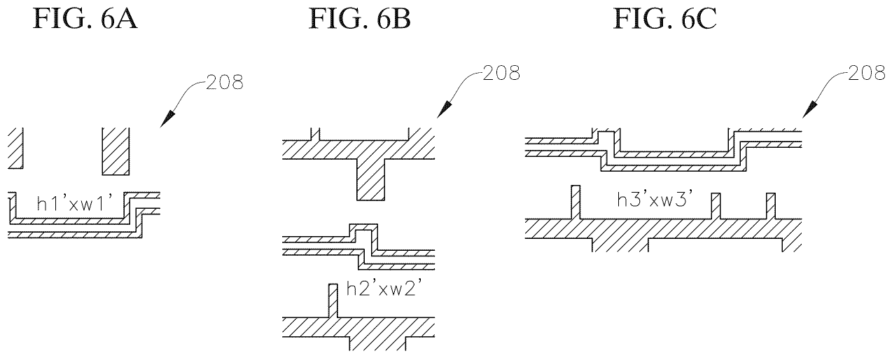

In one or more embodiments, the area(s) of interest 207 (and thus the cropped images 208) may be centered or substantially centered about the centroid 206 of the spot(s) 205. In one or more embodiments, the area(s) of interest 207 (and thus the cropped images 208) may not be centered about the centroid 206 of the spot(s) 205. For instance, in one or more embodiments, the area(s) of interest 207 (and thus the cropped images 208) may be laterally and/or vertically offset relative to the centroid 206 of the spot(s) 205 (i.e., the cropped area may include “jitters”), which increases the diversity of the cropped images 208 in the cropped corpus generated in task 140. Additionally, in one or more embodiments, the tasks 120 and 130 may include defining the area(s) of interest 207 (and thus the cropped images 208) having two or more different configurations, which also increases the diversity of the cropped images in the cropped corpus. For instance, in one or more embodiments, the task 130 may include defining the area(s) of interest 207 (and thus the cropped images 208) with two or more different sizes, two or more different shapes, two or more different orientations, two or more different aspect ratios, and/or two or more different resolutions. FIGS. 6A-6C depict cropped images having different configurations. FIG. 6A depicts a cropped image 208 that is substantially square and has a size h1′×w1′, FIG. 6B depicts a cropped image 208 that is a vertically oriented rectangular shape having a size of h2′×w2′, and FIG. 6C depicts a cropped image 208 that is a horizontally oriented rectangular shape having a size of h3′×w3′.

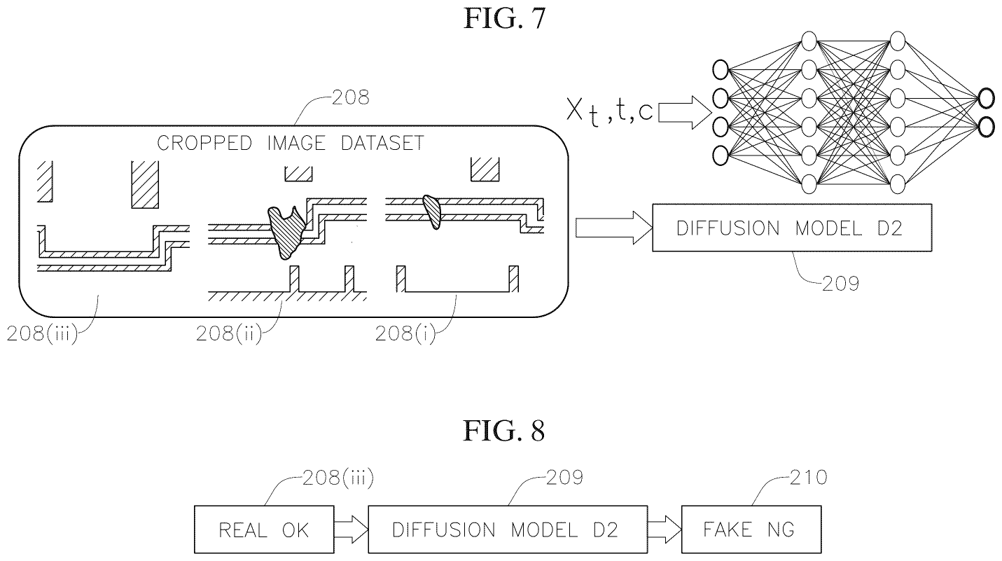

In the illustrated embodiment, the method 100 also includes a task 150 of training a second multi-class conditioned diffusion model (D2) on the corpus of cropped real images 208 generated in task 140 (i.e., cropped real defect images 208 and cropped real defect-free images 208) to generate synthetic defect images. The synthetic defect images have the same resolution as the cropped real images. In one or more embodiments, the task 150 may include training two or more different second diffusion models to generate synthetic defect images having two or more different configurations (e.g., two or more different sizes, two or more different shapes, two or more different orientations, two or more different aspect ratios, and/or two or more different resolutions), which is configured to increase the diversity of the synthetic defect images generated by the second diffusion model 209. FIG. 7 depicts training the second diffusion model 209 on the cropped real images 208 (e.g., the cropped real defect-free image 208(iii) and cropped real defect images 208(i) and 208(ii)).

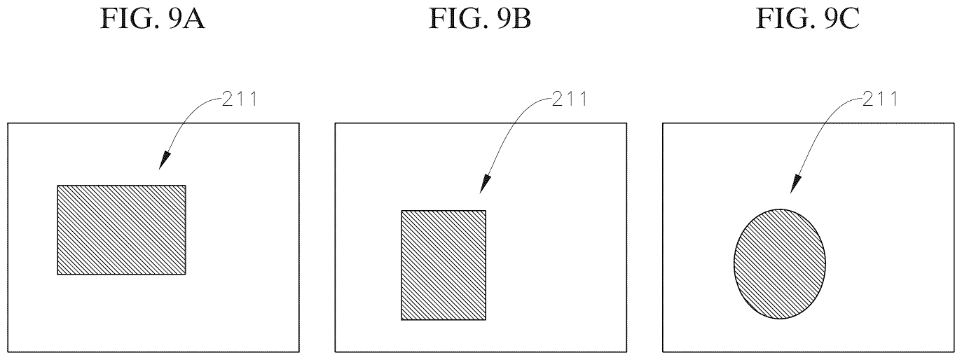

In the illustrated embodiment, the method 100 also includes a task 160 of sampling by supplying the cropped real defect-free images (e.g., cropped real defect-free image 208(iii)) to the second diffusion model 209, which generates synthetic defect images 210. In one or more embodiments, the task 160 may utilize a mask 211 configured to prevent or at least mitigate against introducing defects at the corners and/or edges of the cropped images (i.e., a mask 211 may be utilized to ensure that the corner and/or edge pixels are not altered by the second diffusion model). That is, the second diffusion model 209 is configured to generate synthetic defects within the area of the mask 211 and the pixels outside of the mask 211 remain unaltered. Any suitable type or kind of mask 211 may be utilized, such as RePaint, described in Lugmayr et al., RePaint: Inpainting using Denoising Diffusion Probabilistic Models, arXiv:2201.09865 [cs.CV], the entire content of which is incorporated herein by reference. In one or more embodiments, the configuration (e.g., shape and/or size) of the mask 211 may be varied during the task 160 of generating the synthetic defect images 210 with the second diffusion model 209. For instance, in one or more embodiments, the mask 211 utilized in task 160 may be varied from a horizontally-oriented rectangle, a vertically-oriented rectangle, and an oval. Utilizing two or more different configurations of the mask 211 during the task 160 of generating the synthetic defect images 210 with the second diffuser model 209 is configured to increase the diversity of the defect images generated. FIG. 8 depicts sampling the second diffusion model 209 to generate synthetic defect images 210 from the cropped real defect-free images (e.g., cropped real defect-free image 208(iii)) supplied to the second diffusion model 209 to according to task 160. FIGS. 9A-9C depict masks 211 having different configurations according to task 160. In the embodiment illustrated in FIG. 9A, the mask 211 is a horizontally oriented rectangular shape. In the embodiment illustrated in FIG. 9B, the mask 211 is a vertically oriented rectangular shape. In the embodiment illustrated in FIG. 9C, the mask 211 is a vertically oriented oval shape.

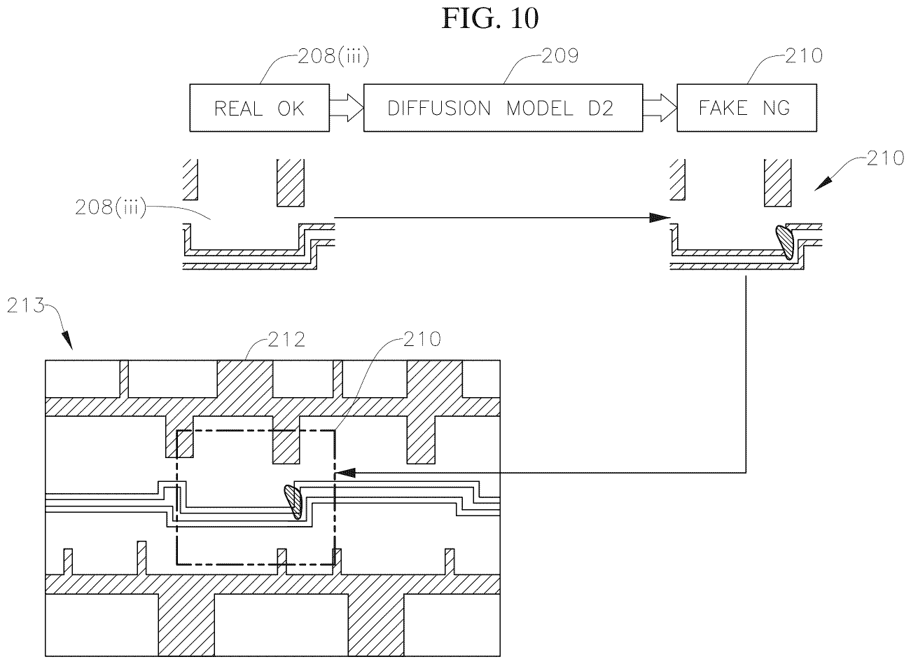

In the illustrated embodiment, the method 100 also includes a task 170 of superimposing the synthetic defect images 210 generated in task 160 on the real defect-free high-resolution images 212 to generate high-resolution synthetic defect images 213. This task 170 utilizes the coordinates of the cropped area (i.e., the area(s) of interest 207) to ensure that the lower-resolution synthetic defect image 210 is superimposed at the correct location in the higher-resolution image 212. Additionally, the utilization of the mask 211 in task 160, which ensured that the corners and/or edges of the cropped images were unaltered during the generation of the synthetic defect images 210, is configured to ensure that the synthetic defect images 210 matches (or is consistent with) the remainder of the real defect-free high-resolution image 212 once it is superimposed on the real defect-free high-resolution image 212. FIG. 10 depicts superimposing a cropped synthetic defect image 210 on a real defect-free high-resolution image 212 to generate a high-resolution synthetic defect image 213 according to task 170. In this manner, the method 100 is configured to generate additional high-resolution synthetic defect images without the processing power required by related art methods.

In one or more embodiments, the method 100 may also include a task 180 of training an AI-based classifier on the relatively high-resolution synthetic defect images generated in task 170 and on the relatively high-resolution defect-free images to detect defect(s) in the display device during one or more manufacturing stages. In one or more embodiments, the number of high-resolution synthetic defect images may be substantially equal to the number of high-resolution defect-free images utilized to train the Al-based classifier in task 180, which is configured to result in a more robust Al-based classifier compared to an Al-based classifier that is trained on fewer defect images.

In one or more embodiments, the method 100 may also include a task 190 of auto-repairing the defect(s) detected by the Al-based classifier in task 180.

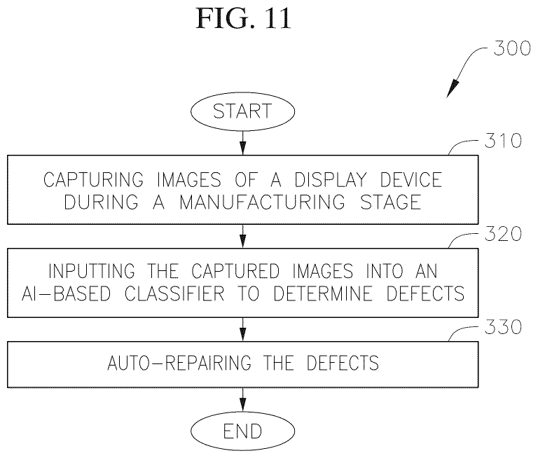

FIG. 11 is a flowchart illustrating tasks of a method 300 of repairing defects in a display device (e.g., organic light-emitting diode (OLED) devices or quantum dot organic light-emitting diode (QD-OLED) devices) during a process of manufacturing the display device according to one embodiment of the present disclosure.

In the illustrated embodiment, the method 300 includes a task 310 of capturing or obtaining one or more images of a display device (e.g., organic light-emitting diode (OLED) devices or quantum dot organic light-emitting diode (QD-OLED) devices) during one or more manufacturing stages of the display device.

In the illustrated embodiment, the method 300 also includes a task 320 of inputting the one or more images of the display device (obtained in task 310) into an AI-based classifier to determine the presence of defects in the display device during one or more manufacturing stages. In one or more embodiments, the AI-based classifier was trained on the relatively high-resolution synthetic defect images generated in method 300 and on relatively high-resolution defect-free images. In one or more embodiments, the number of high-resolution synthetic defect images may be substantially equal to the number of high-resolution defect-free images utilized to train the Al-based classifier in task 180, which is configured to result in a more robust Al-based classifier compared to an AI-based classifier that is trained on fewer defect images.

In one or more embodiments, the method 300 may also include a task 330 of auto-repairing the defect(s) detected by the AI-based classifier in task 320.

Although the method 100 is described above for generating synthetic defect images, in one or more embodiments the methods of the present disclosure may be utilized to generate any other suitable type or kind of synthetic images. FIG. 11 depicts a method 300 of generating synthetic images containing an object of interest according to one embodiment of the present disclosure.

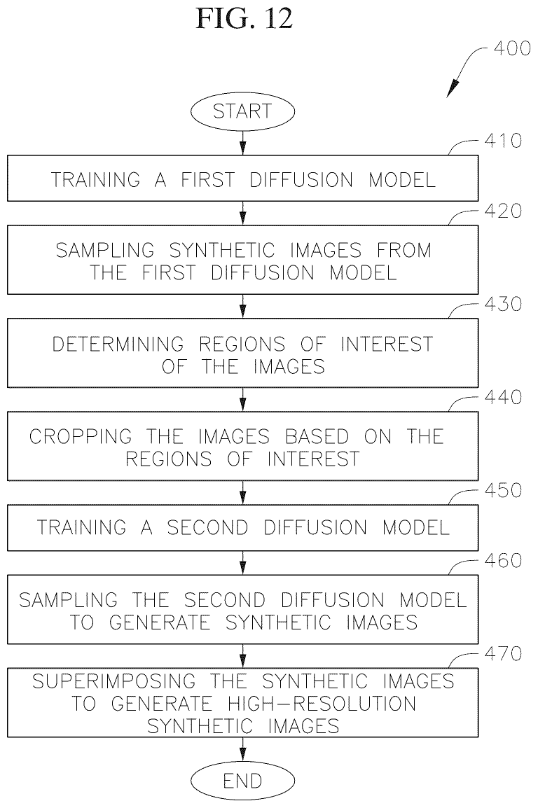

As illustrated in FIG. 12, the method 400 includes a task 410 of training a first diffusion model on a corpus of images to generate images at a lower resolution than the images input into the first diffusion model (i.e., the first diffusion model is trained to resize images from a relatively high-resolution to a relatively lower resolution). For instance, in one or more embodiments, the task 410 may include training the first diffusion model to resize images having a resolution of 2048×2048 to images having a resolution of 512×512, although in one or more embodiments the higher resolution images and the lower resolution images may have any other suitable resolutions and the images may not be square.

In the illustrated embodiment, the method 400 also includes a task 420 of sampling images having an object of interest and images not having an object of interest from the first diffusion model that was trained in task 410. In the forward diffusion process, the first diffusion model is configured to iteratively add noise to the real image. In the reverse diffusion process, the first diffusion model is configured to denoise the image with class label c (desired synthetic image) to generate the synthetic image.

In the illustrated embodiment, the method 400 also includes a task 430 of determining regions of interest of the synthetic images. In one or more embodiments, the task 330 of determining the region(s) of interest includes determining (e.g., calculating or computing) a difference between the real image supplied to the first diffusion model and the corresponding synthetic image generated by the first diffusion model and/or the difference between the real image supplied to the first diffusion model and the corresponding synthetic image generated by the first diffusion model.

In the illustrated embodiment, the method 400 also includes a task 440 of cropping the original high-resolution images based on the region(s) of interest determined in task 430. In this manner, the task 440 generates a corpus of cropped real images containing the object of interest and cropped real images not containing the object of interest.

In the illustrated embodiment, the method 400 also includes a task 450 of training a second multi-class conditioned diffusion model on the corpus of cropped real images generated in task 440 (i.e., cropped real images containing the object of interest and the cropped real images not containing the object of interest) to generate synthetic images having the object of interest. The synthetic images have the same resolution as the cropped real images.

In the illustrated embodiment, the method 400 also includes a task 460 of sampling by supplying the cropped real images not containing the object of interest to the second diffusion model, which generates synthetic images containing the object of interest.

In the illustrated embodiment, the method 400 also includes a task 470 of superimposing the synthetic images containing the object of interest generated in task 460 on the real high-resolution images not containing the object of interest to generate high-resolution synthetic images containing the object of interest. This task 470 utilizes the coordinates of the cropped area (i.e., the area(s) of interest) to ensure that the lower-resolution synthetic image containing the object of interest is superimposed at the correct location in the higher-resolution image. In this manner, the method 400 is configured to generate additional high-resolution synthetic images containing an object of interest without the processing power required by related art methods.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of generating a plurality of high-resolution synthetic images, the method comprising:
training a first multi-class-conditioned diffusion model on a corpus comprising a plurality of real images of a first class and a plurality of real images of a second class
generating, utilizing the first multi-class-conditioned diffusion model, a synthetic image of the first class from a real image of the second class, and a synthetic image of the second class from a real image of the first class;
determining, utilizing the first multi-class-conditioned diffusion model, at least one region of interest of the plurality of real images of the second class;
cropping the plurality of real images of the first class and the plurality of real images of the second class based on the at least one region of interest to generate a corpus of cropped images;
training a second multi-class-conditioned diffusion model on the corpus of cropped images;
generating, with the second multi-class-conditioned diffusion model, a plurality of synthetic images of the first class from the corpus of cropped images; and
superimposing the plurality of synthetic images of the first class on the plurality of real images of the second class to generate the plurality of high-resolution synthetic images.

2. The method of claim 1, wherein:
the plurality of real images of the first class is a plurality of real defect images of a display device at a stage during a manufacturing process;
the plurality of real images of the second class is a plurality of real defect-free images of the display device at the stage during the manufacturing process;
the plurality of synthetic images of the first class is a plurality of synthetic defect images;
the synthetic image of the first class is a synthetic defect image;
the real image of the second class is a real defect-free image;
the synthetic image of the second class is a synthetic defect-free image;
the real image of the first class is a real defect image; and
the plurality of high-resolution synthetic images is a plurality of high-resolution synthetic defect images.

3. The method of claim 2, wherein the determining the region of interest comprises:
determining at least one difference between the synthetic defect image and the real defect-free image or between the synthetic defect-free image and the real defect image;
separating, utilizing a connected components algorithm, the at least one difference into at least one distinct spot representing a defect; and
determining a centroid of the at least one distinct spot.

4. The method of claim 3, wherein the region of interest is centered about the centroid.

5. The method of claim 3, wherein the region of interest is offset with respect to the centroid.

6. The method of claim 1, wherein the at least one region of interest comprises a plurality of regions of interest having different configurations.

7. The method of claim 6, wherein the plurality of regions of interest comprises a first region of interest having a first shape and a second region of interest having a second shape different than the first shape.

8. The method of claim 6, wherein the plurality of regions of interest comprises a first region of interest having a first orientation and a second region of interest having a second orientation different than the first orientation.

9. The method of claim 6, wherein the plurality of regions of interest comprises a first region of interest having a first aspect ratio and a second region of interest having a second aspect ratio different than the first aspect ratio.

10. The method of claim 6, wherein the plurality of regions of interest comprises a first region of interest having a first resolution and a second region of interest having a second shape resolution than the first resolution.

11. The method of claim 1, wherein the generating the plurality of synthetic images of the first class comprises utilizing at least one mask.

12. The method of claim 11, wherein the at least one mask comprises a plurality of masks having different configurations.

13. The method of claim 2, further comprising training an artificial intelligence classifier on the plurality of high-resolution synthetic defect images to detect defects in the display device.

14. The method of claim 13, further comprising auto-repairing the defects in the display device.

15. The method of claim 1, wherein the synthetic image of the first class has a low-resolution and real image of the second class has a high-resolution, and wherein the synthetic image of the second class has the low-resolution and the real image of the first class has the high-resolution.

16. The method of claim 15, wherein the high-resolution is 2048×2048, and wherein the low-resolution is 512×512.

17. The method of claim 1, wherein training the second multi-class-conditioned diffusion model comprises training a plurality of second multi-class-conditioned diffusion models to generate a plurality of the plurality of synthetic images of the first class having a plurality of different configurations.

18. The method of claim 17, wherein the training the plurality of second multi-class-conditioned diffusion models comprises training one of the plurality of second multi-class-conditioned diffusion models to generate first synthetic images of the first class having a first size and training another one of the plurality of second multi-class-conditioned diffusion models to generate second synthetic images of the first class having a second size different than the first size.

19. The method of claim 17, wherein the training the plurality of second multi-class-conditioned diffusion models comprises training one of the plurality of second multi-class-conditioned diffusion models to generate first synthetic images of the first class having a first shape and training another one of the plurality of second multi-class-conditioned diffusion models to generate second synthetic images of the first class having a second shape different than the first shape.

20. The method of claim 17, wherein the training the plurality of second multi-class-conditioned diffusion models comprises training one of the plurality of second multi-class-conditioned diffusion models to generate first synthetic images of the first class having a first orientation and training another one of the plurality of second multi-class-conditioned diffusion models to generate second synthetic images of the first class having a second orientation different than the first orientation.

21. The method of claim 17, wherein the training the plurality of second multi-class-conditioned diffusion models comprises training one of the plurality of second multi-class-conditioned diffusion models to generate first synthetic images of the first class having a first resolution and training another one of the plurality of second multi-class-conditioned diffusion models to generate second synthetic images of the first class having a second resolution different than the first resolution.
